(19) United States
(12) Patent Application Publication
(10) Pub. No.: US 2024/0135310 A1
(43) Pub. Date: Apr. 25, 2024

(54) INFORMATION PROCESSING DEVICE, INFORMATION PROCESSING SYSTEM, AND INFORMATION PROCESSING METHOD

(71) Applicant: Mitsubishi Electric Corporation, Tokyo (JP)

(72) Inventors: Yoshie IMAI, Tokyo (JP); Kentaro ISHIKAWA, Tokyo (JP); Shunya OSAWA, Tokyo (JP); Masato TSUCHIYA, Tokyo (JP); Yoshiki MITSUI, Tokyo (JP); Nobuaki MOTOYAMA, Tokyo (JP); Satoru FURUTA, Tokyo (JP); Masahiro ABUKAWA, Tokyo (JP)

(73) Assignee: Mitsubishi Electric Corporation, Tokyo (JP)

(21) Appl. No.: 18/400,364

(22) Filed: Dec. 29, 2023

Related U.S. Application Data
(63) Continuation of application No. PCT/JP2021/026819, filed on Jul. 16, 2021.

(51) Int. Cl. G06Q 10/0834; G06Q 30/04

(52) U.S. Cl. CPC G06Q 10/08345; G06Q 30/04

(57) ABSTRACT

An information processing device includes an acquisition unit that acquires mobile object information, parcel information, pickup delivery information as information regarding at least one of pickup and delivery, map information, weather information, and traffic information, a calculation control unit that calculates a delivery company burden, as a cost defrayment by a delivery company, in regard to each combination of target parcels and a mobile object by using the mobile object information, the parcel information, the pickup delivery information, the map information, the weather information and the traffic information, a determination unit that determines an optimum combination out of a plurality of combinations based on the delivery company burden calculated in regard to each combination of target parcels and a mobile object, and an output unit that outputs the optimum combination.

### CROSS-REFERENCE TO RELATED APPLICATION

This application is a continuation application of International Application No. PCT/JP2021/026819 having an international filing date of Jul. 16, 2021, which is hereby expressly incorporated by reference into the present application.

### BACKGROUND OF THE INVENTION

### 1. Field of the Invention

The present disclosure relates to an information processing device, an information processing system, and an information processing method.

### 2. Description of the Related Art

The amount of physical distribution of parcels is increasing in recent years. Accordingly, efficiency improvement of pickup and delivery is being requested. There has been proposed a pickup and delivery system for realizing the efficiency improvement of the pickup and delivery (see Patent Reference 1).

Patent Reference 1: Japanese Patent Application Publication No. 2002-215745

As mentioned above, the amount of physical distribution of parcels is increasing in recent years. Accordingly, working hours of a driver or the like are increasing. With the increase in the working hours, a labor cost as the payment to drivers and the like increases. Then, with the increase in the labor cost, a cost defrayment by a delivery company increases. Therefore, how to reduce the cost defrayment by the delivery company is an important issue.

### SUMMARY OF THE INVENTION

An object of the present disclosure is to increase the level of satisfaction of the delivery company.

An information processing device according to an aspect of the present disclosure is provided. The information processing device includes an acquisition unit that acquires mobile object information as information regarding a plurality of mobile objects and including information indicating whether each of the plurality of mobile objects is a manned mobile object or an unmanned mobile object, parcel information as information regarding target parcels as one or more parcels, pickup delivery information as information regarding at least one of pickup and delivery, map information, weather information, and traffic information, a calculation control unit that calculates a delivery company burden, as a cost defrayment by a delivery company, in regard to each combination of target parcels and a mobile object by using the mobile object information, the parcel information, the pickup delivery information, the map information, the weather information and the traffic information, a determination unit that determines an optimum combination out of a plurality of combinations based on the delivery company burden calculated in regard to each combination of target parcels and a mobile object, and an output unit that outputs the optimum combination.

According to the present disclosure, the level of satisfaction of a delivery company can be increased.

### BRIEF DESCRIPTION OF THE DRAWINGS

The present disclosure will become more fully understood from the detailed description given hereinbelow and the accompanying drawings which are given by way of illustration only, and thus are not limitative of the present disclosure, and wherein:

FIG. 1 is a diagram showing an information processing system;

FIG. 2 is a diagram showing hardware included in the information processing device;

FIG. 3 is a block diagram showing functions of the information processing device and a server;

FIG. 4 is a diagram showing an example of a result list; and

FIG. 5 is a flowchart showing an example of a process executed by the information processing device.

### DETAILED DESCRIPTION OF THE INVENTION

An embodiment will be described below with reference to the drawings. The following embodiment is just an example and a variety of modifications are possible within the scope of the present disclosure.

### Embodiment

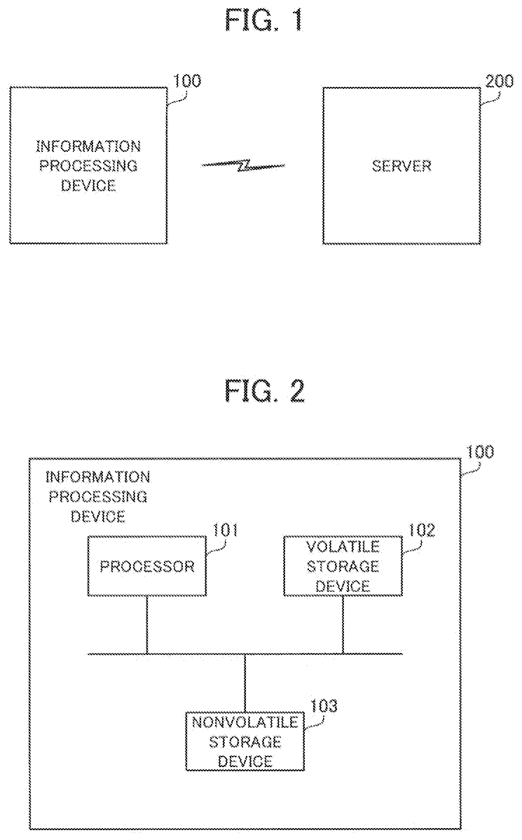

FIG. 1 is a diagram showing an information processing system. The information processing system includes an information processing device 100 and a server 200. The information processing device 100 and the server 200 are connected to each other via a network. Incidentally, the network is a wired network or a wireless network.

The information processing device 100 is a device used by a delivery company. Incidentally, the delivery company can be regarded as a legal person such as a company. The information processing device 100 is a device that executes an information processing method.

FIG. 1 shows one server. However, the number of servers can also be two or more.

Next, hardware included in the information processing device 100 will be described below.

FIG. 2 is a diagram showing the hardware included in the information processing device. The information processing device 100 includes a processor 101, a volatile storage device 102 and a nonvolatile storage device 103.

The processor 101 controls the whole of the information processing device 100. The processor 101 is a Central Processing Unit (CPU), a Field Programmable Gate Array (FPGA) or the like, for example. The processor 101 can also be a multiprocessor. Further, the information processing device 100 may include a processing circuitry. The processing circuitry may be either a single circuit or a combined circuit.

The volatile storage device 102 is main storage of the information processing device 100. The volatile storage device 102 is a Random Access Memory (RAM), for example. The nonvolatile storage device 103 is auxiliary storage of the information processing device 100. The nonvolatile storage device 103 is a Hard Disk Drive (HDD) or a Solid State Drive (SSD), for example.

The server 200 includes a processor, a volatile storage device and a nonvolatile storage device similarly to the information processing device 100. The server 200 may include a processing circuitry.

Next, functions of the information processing device 100 and the server 200 will be described below.

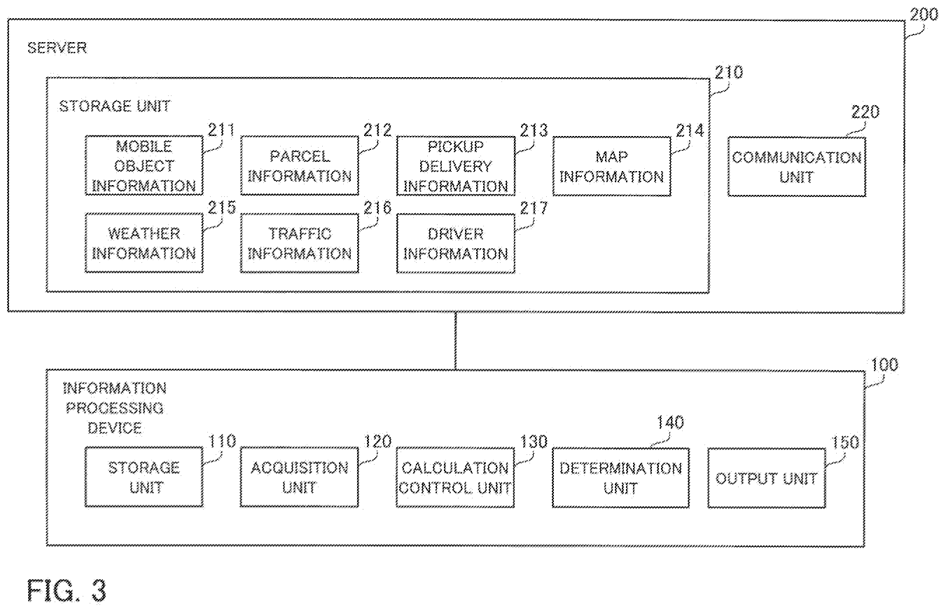

FIG. 3 is a block diagram showing the functions of the information processing device and the server. The information processing device 100 includes a storage unit 110, an acquisition unit 120, a calculation control unit 130, a determination unit 140 and an output unit 150.

The storage unit 110 may be implemented as a storage area reserved in the volatile storage device 102 or the nonvolatile storage device 103.

Part or all of the acquisition unit 120, the calculation control unit 130, the determination unit 140 and the output unit 150 may be implemented by a processing circuitry. Further, part or all of the acquisition unit 120, the calculation control unit 130, the determination unit 140 and the output unit 150 may be implemented as modules of a program executed by the processor 101. For example, the program executed by the processor 101 is referred to also as an information processing program. The information processing program has been recorded in a record medium, for example.

The server 200 includes a storage unit 210 and a communication unit 220. The storage unit 210 may be implemented as a storage area reserved in the volatile storage device or the nonvolatile storage device included in the server 200. Part or the whole of the communication unit 220 may be implemented by the processing circuitry included in the server 200. Further, part or the whole of the communication unit 220 may be implemented as modules of a program executed by the processor included in the server 200.

First, the functions of the server 200 will be described below before describing the functions of the information processing device 100.

The storage unit 210 may store mobile object information 211, parcel information 212, pickup delivery information 213, map information 214, weather information 215, traffic information 216 and driver information 217.

The mobile object information 211 is information regarding a plurality of mobile objects. For example, the mobile object information 211 indicates the type of each mobile object. Incidentally, the mobile object is a truck, a bicycle, a hand truck, a threeter (three-wheeled scooter), an Autonomous Mobility Robot (AMR), an electric train, a bus, a drone or the like, for example. Further, the mobile object is referred to also as mobility. The mobile object information 211 includes, for example, information indicating whether each of the plurality of mobile objects is a manned mobile object or an unmanned mobile object (in other words, information indicating whether each of the plurality of mobile objects is capable of autonomous driving or not). The mobile object information 211 is, for example, a present position of each of the plurality of mobile objects, information indicating whether each of the plurality of mobile objects can be dispatched or not, information acquired from a sensor mounted on each of the plurality of mobile objects, or the like. Specifically, the information acquired from the sensor mounted on each of the plurality of mobile objects is, for example, position information acquired from a Global Navigation Satellite System (GNSS) or an Inertial Navigation System (INU), physiological information or surrounding environment information regarding a driver acquired from a Driver Monitoring System (DMS) or a driver recorder, or the like. Further, for example, the mobile object information 211 includes fuel information as information regarding the fuel of each of the plurality of mobile objects. For example, the fuel information is a maximum fuel payload, a remaining fuel amount, a fuel consumption per unit time, a unit price of the fuel, and so forth. Incidentally, in cases where the mobile object is driven by electricity, the fuel is electricity or hydrogen.

The parcel information 212 is information regarding one or more parcels. The one or more parcels are referred to as target parcels. For example, the parcel information 212 is information indicating whether each parcel is before pickup, before sorting at the pickup center, or after sorting at the pickup center. Further, for example, the parcel information 212 can be the position where the parcel is located, information regarding the recipient of the parcel, information regarding the sender of the parcel (e.g., requester of the delivery), information indicating the size of the parcel, the shape of the parcel, the name of the parcel, and whether the parcel is a fragile article or not, information indicating whether or not the parcel needs refrigeration storage or cold storage, and so forth. Incidentally, the information regarding the recipient is the recipient's address or the like, for example. The information regarding the sender is the sender's address or the like, for example.

The pickup delivery information 213 is information regarding at least one of pickup and delivery. In short, there is a case where the pickup delivery information 213 is information regarding pickup. Further, there is a case where the pickup delivery information 213 is information regarding delivery. Furthermore, there is a case where the pickup delivery information 213 is information regarding pickup and delivery.

For example, the pickup delivery information 213 is the recipient's home address or the sender's home address. The pickup delivery information 213 may also indicate a pickup delivery designation position instead of the recipient's or other person's home address. When the recipient wants to receive the parcel at a designated position, the pickup delivery designation position indicates the position designated by the recipient (hereinafter referred to as a recipient designation position). When the sender wants to have the parcel picked up at a designated position, the pickup delivery designation position indicates the position designated by the sender (hereinafter referred to as a sender designation position). Specifically, the pickup delivery designation position is a home delivery box, a convenience store, the present position of the recipient or the sender, or the like. Specifically, the pickup delivery designation position can be a business establishment, a store in a shopping center or a department store, a room in a hotel, or the like. In short, the specific pickup delivery designation position can be a place of pickup delivery in a business. As above, the pickup delivery designation position may indicate a position freely designated by at least one of the recipient and the sender. Further, for example, the pickup delivery information 213 indicates a pickup delivery designation time. Specifically, the pickup delivery information 213 can indicate a reception time designated by the recipient (hereinafter referred to as a recipient designation time). Further, the pickup delivery information 213 can indicate a pickup time designated by the sender (hereinafter referred to as a sender designation time).

The map information 214 is information regarding a map. For example, the map information 214 indicates a map of a pickup delivery area.

The weather information 215 is information regarding weather. For example, the weather information 215 indicates the weather in the pickup delivery area.

The traffic information 216 is information regarding traffic. For example, the traffic information 216 can be traffic jam information or construction/repair information. Further, the traffic information 216 can be information indicating that the number of lanes has decreased due to occurrence of an accident.

The driver information 217 is information regarding the driver. For example, the driver information 217 can indicate the name of the driver, the age of the driver, the gender of the driver, the mobile object that the driver can drive, information indicating whether the driver is in a workable condition or not, the working hour limit of the driver, and so forth.

The communication unit 220 transmits information stored in the storage unit 210 to the information processing device 100 when the communication unit 220 receives a transmission command regarding the information stored in the storage unit 210 from the information processing device 100.

Incidentally, in cases where the information processing system includes a plurality of servers, each of the plurality of servers may store any item(s) of information out of the mobile object information 211, the parcel information 212, the pickup delivery information 213, the map information 214, the weather information 215, the traffic information 216 and the driver information 217.

Next, the functions of the information processing device 100 will be described below.

The storage unit 110 may store the mobile object information 211, the parcel information 212, the pickup delivery information 213, the map information 214, the weather information 215, the traffic information 216 and the driver information 217.

The acquisition unit 120 acquires the mobile object information 211, the parcel information 212, the pickup delivery information 213, the map information 214, the weather information 215, the traffic information 216 and the driver information 217. For example, the acquisition unit 120 acquires these items of information from the server 200. Specifically, the information processing device 100 transmits a transmission command regarding these items of information to the server 200, and accordingly, the acquisition unit 120 acquires these items of information from the server 200. Alternatively, for example, the acquisition unit 120 acquires these items of information from the storage unit 110.

Incidentally, the acquisition unit 120 acquires the driver information 217 when a manned mobile object exists in the plurality of mobile objects indicated by the mobile object information 211. In other words, the acquisition unit 120 does not acquire the driver information 217 when the plurality of mobile objects indicated by the mobile object information 211 are unmanned mobile objects. In the following description, the acquisition unit 120 is assumed to acquire the driver information 217.

The calculation control unit 130 calculates a delivery company burden in regard to each combination of parcels and a mobile object by using the mobile object information 211, the parcel information 212, the pickup delivery information 213, the map information 214, the weather information 215, the traffic information 216 and the driver information 217. Specifically, the calculation control unit 130 calculates the delivery company burden in regard to each combination of parcels and a mobile object by comprehensively using the mobile object information 211, the parcel information 212, the pickup delivery information 213, the map information 214, the weather information 215, the traffic information 216 and the driver information 217. The calculation control unit 130 may calculate the delivery company burden in regard to each combination of parcels and a mobile object by using the mobile object information 211, the parcel information 212, the pickup delivery information 213, the map information 214, the weather information 215, the traffic information 216, the driver information 217, and a rulebase. Further, the calculation control unit 130 may calculate the delivery company burden in regard to each combination of parcels and a mobile object by using the mobile object information 211, the parcel information 212, the pickup delivery information 213, the map information 214, the weather information 215, the traffic information 216, the driver information 217, and a learned model. In the case where a learned model is used, the acquisition unit 120 acquires the learned model from the storage unit 110 or the server 200.

Incidentally, the delivery company burden means the cost defrayment by the delivery company. Specifically, the delivery company burden is the cost as the payment to drivers, people participating in the delivery service, and so forth (i.e., labor cost). The delivery company burden may be represented by a burden ratio of the delivery company in terms of a numerical value or an amount of money. The delivery company burden may be represented by “the burden is heavy” or “the burden is light”. In cases of overtime work (i.e., extra work), the labor cost is generally set higher than that in cases of working for prescribed working hours.

The calculation control unit 130 may calculate at least one of the working hours of the driver and the burden on the driver by using the mobile object information 211, the parcel information 212, the pickup delivery information 213, the map information 214, the weather information 215, the traffic information 216 and the driver information 217. The working hours of the driver and the burden on the driver may be calculated by comprehensively using these items of information. The working hours of the driver and the burden on the driver may be calculated by using a rulebase or a learned model. The physiological information may be used for the calculation of the driver burden.

As mentioned earlier, the driver information 217 is not acquired when the plurality of mobile objects indicated by the mobile object information 211 are unmanned mobile objects. Therefore, when the plurality of mobile objects indicated by the mobile object information 211 are unmanned mobile objects, the calculation control unit 130 calculates the delivery company burden in regard to each combination of parcels and a mobile object without using the driver information 217. Further, when the plurality of mobile objects indicated by the mobile object information 211 are unmanned mobile objects, the calculation control unit 130 may calculate the working hours of the driver and the burden on the driver without using the driver information 217.

The calculation control unit 130 may generate information indicating whether manpower is necessary or not in regard to each combination of parcels and a mobile object. For example, when the mobile object information 211 indicates unmanned mobile objects, the calculation control unit 130 generates information indicating that no human hand is necessary. Further, for example, the calculation control unit 130 generates the information indicating whether manpower is necessary or not based on the size of the parcel indicated by the parcel information 212. For example, when manpower is necessary, the calculation control unit 130 may calculate the number of man-hours based on the mobile object information 211, the parcel information 212 and the pickup delivery information 213.

The calculation control unit 130 may calculate a pickup delivery time in regard to each combination of parcels and a mobile object. For example, the calculation control unit 130 calculates the pickup delivery time based on the mobile object information 211, the parcel information 212, the pickup delivery information 213, the map information 214, the weather information 215 and the traffic information 216.

Incidentally, the pickup delivery time is a time for which at least one of pickup and delivery is carried out. In short, there are cases where the pickup delivery time is a time for which pickup is carried out. Further, there are cases where the pickup delivery time is a time for which delivery is carried out. Furthermore, there are cases where the pickup delivery time is a time for which pickup and delivery are carried out.

The calculation control unit 130 may calculate a travel distance in regard to each combination of parcels and a mobile object. For example, the calculation control unit 130 calculates the travel distance based on the mobile object information 211, the parcel information 212, the pickup delivery information 213, the map information 214, the weather information 215 and the traffic information 216.

Incidentally, the travel distance is a distance in at least one of pickup and delivery. In short, there are cases where the travel distance is the distance in pickup. Further, there are cases where the travel distance is the distance in delivery. Furthermore, there are cases where the travel distance is the distance in pickup and delivery.

The calculation control unit 130 may calculate the fuel consumption of the mobile object in at least one of pickup and delivery in regard to each combination of parcels and a mobile object. For example, the calculation control unit 130 calculates the fuel consumption in pickup and delivery based on the fuel information included in the mobile object information 211 and the travel distance.

The calculation control unit 130 may calculate a fuel bill in regard to each combination of parcels and a mobile object. For example, the calculation control unit 130 calculates the fuel bill in pickup and delivery based on the unit price of the fuel indicated by the fuel information included in the mobile object information 211 and the fuel consumption.

When calculating the information indicating whether manpower is necessary or not, the pickup delivery time, the travel distance, the fuel consumption and the fuel bill, the calculation control unit 130 may assign weights varying depending on the type of the mobile object, and calculate the information indicating whether manpower is necessary or not, the pickup delivery time, the travel distance, the fuel consumption and the fuel bill of the mobile object.

Incidentally, the information indicating whether manpower is necessary or not, the pickup delivery time, the travel distance, the fuel consumption and the fuel bill may be calculated or generated by using a learned model.

In the following description, the calculation control unit 130 is assumed to calculate or generate the delivery company burden, the information indicating whether manpower is necessary or not, the pickup delivery time, the travel distance, the fuel consumption and the fuel bill. Further, the delivery company burden, the information indicating whether manpower is necessary or not, the pickup delivery time, the travel distance, the fuel consumption and the fuel bill are referred to as a travel cost. The travel cost can include a maintenance cost for the mobile object, a retainment cost, a waiting time of the mobile object, and so forth. Incidentally, the retainment cost is a tax and the like.

Next, an example of a result list of the calculation control unit 130 will be shown below.

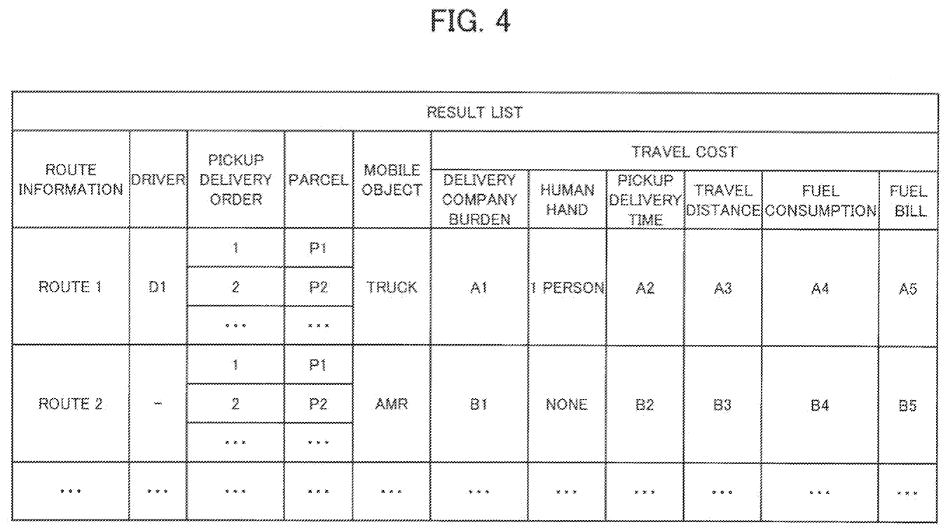

FIG. 4 is a diagram showing an example of the result list. FIG. 4 illustrates an example of the result list. As shown in the result list, the travel cost is calculated in regard to each combination of one or more parcels and a mobile object. Further, as shown in FIG. 4, route information, the driver and pickup delivery order may be associated with the travel cost.

As above, the information processing device 100 is capable of obtaining a plurality of combinations.

The determination unit 140 determines an optimum combination out of the plurality of combinations based on the travel cost. For example, the determination unit 140 determines a combination whose delivery company burden is at the minimum as the optimum combination. Further, the determination unit 140 may determine important information among the items of information included in the travel cost other than the delivery company burden and determine the optimum combination while attaching importance to the delivery company burden and the important information. Furthermore, the determination unit 140 may determine the optimum combination by using a rulebase or a learned model.

Here, the optimum combination is a combination that minimizes the burden on the delivery company. For example, a combination with a high cost for the payment to the driver is unlikely to be determined as the optimum combination. Further, for example, when manpower is necessary, the labor cost increases. Therefore, a combination in a case where a more than one person is necessary is unlikely to be determined as the optimum combination. Furthermore, in cases where the mobile object is a manned mobile object and the pickup delivery time and a travel time are long, for example, the working hours of the driver become long and overtime work can occur. If overtime work is occurred, the delivery company needs to pay the overtime money to the driver. Therefore, a combination in a case where the mobile object is a manned mobile object and the pickup delivery time and the travel time are long is unlikely to be determined as the optimum combination.

Further, in the determination of the optimum combination, it is possible to combine the fuel bill, for example, with the burden on the delivery company. For example, when the fuel consumption is high, the delivery company needs to supply the fuel to the mobile object later. The cost for supplying the fuel is a burden on the delivery company. Therefore, a combination in a case where the fuel consumption is high is unlikely to be determined as the optimum combination. Further, for example, when the fuel bill is high, the high fuel bill is a heavy burden on the delivery company. Therefore, a combination in a case where the fuel bill is high is unlikely to be determined as the optimum combination.

As above, the determination unit 140 determines a combination that minimizes the burden on the delivery company as the optimum combination. For example, out of the plurality of combinations, the determination unit 140 determines the combination of the parcels “P1”, . . . and the mobile object “AMR” as the optimum combination.

The output unit 150 outputs the optimum combination. For example, the output unit 150 outputs the optimum combination to a display connected to the information processing device 100. Incidentally, illustration of the display in a drawing is left out. It is also possible for the output unit 150 to output the optimum combination to a different device.

Here, when the pickup delivery information 213 includes the recipient designation position and the recipient designation time, the acquisition unit 120 may acquire the present position of the recipient. For example, the acquisition unit 120 acquires the present position of the recipient from the recipient's terminal device. Then, the calculation control unit 130 judges whether the parcel can be delivered to the recipient designation position at the recipient designation time or not based on the mobile object information 211, the parcel information 212, the pickup delivery information 213, the map information 214, the weather information 215, the traffic information 216 and the present position of the recipient. Here, it is also possible for the calculation control unit 130 to judge whether the parcel can be delivered to the recipient designation position at the recipient designation time or not by further using the driver information 217. The output unit 150 outputs the result of the judgment to the recipient's terminal device. This enables the recipient to grasp whether or not the parcel can be received at the recipient designation position at the recipient designation time.

Further, when the pickup delivery information 213 includes the recipient designation position, the acquisition unit 120 may acquire the present position of the recipient. Then, the calculation control unit 130 calculates a time when the recipient can receive the parcel at the recipient designation position based on the mobile object information 211, the parcel information 212, the pickup delivery information 213, the map information 214, the weather information 215, the traffic information 216 and the present position of the recipient. Here, it is also possible for the calculation control unit 130 to calculate the time by further using the driver information 217. The output unit 150 outputs the calculated time to the recipient's terminal device. This enables the recipient to grasp the time when the parcel can be received at the recipient designation position.

Next, a process executed by the information processing device 100 will be described below by using a flowchart.

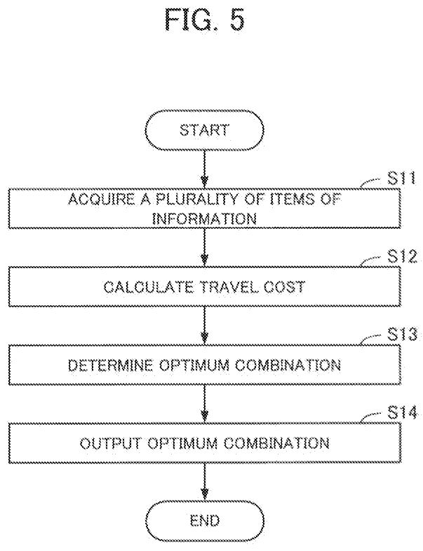

FIG. 5 is a flowchart showing an example of the process executed by the information processing device.

(Step S11) The acquisition unit 120 acquires the mobile object information 211, the parcel information 212, the pickup delivery information 213, the map information 214, the weather information 215, the traffic information 216 and the driver information 217.

(Step S12) The calculation control unit 130 calculates the travel cost in regard to each combination of parcels and a mobile object by using the mobile object information 211, the parcel information 212, the pickup delivery information 213, the map information 214, the weather information 215, the traffic information 216 and the driver information 217.

(Step S13) The determination unit 140 determines the optimum combination out of the plurality of combinations based on the travel cost.

(Step S14) The output unit 150 outputs the optimum combination.

According to the embodiment, the information processing device 100 determines a combination that minimizes the burden on the delivery company as the optimum combination. Then, the information processing device 100 outputs the optimum combination. If the delivery company makes arrangements according to the optimum combination, the cost defrayment by the delivery company is reduced. Accordingly, the outputting of the optimum combination by the information processing device 100 can increase the level of satisfaction of the delivery company.

Further, the information processing device 100 determines a combination that also minimizes the travel cost such as the fuel bill, being a cost other than the burden on the delivery company, as the optimum combination. Then, the information processing device 100 outputs the optimum combination. If the delivery company makes arrangements according to the optimum combination, the cost defrayment by the delivery company is reduced. Accordingly, the outputting of the optimum combination by the information processing device 100 can increase the level of satisfaction of the delivery company.

Furthermore, the information processing device 100 determines a combination that reduces the pickup delivery time, the travel time or the like as the optimum combination. If the delivery company makes arrangements according to the optimum combination, the recipient or the sender can receive or send out the parcel on time. Accordingly, the outputting of the optimum combination by the information processing device 100 can also increase the level of satisfaction of the recipient or the sender.

The above description has been given of cases where the optimum combination is determined by using the delivery company burden, the information indicating whether manpower is necessary or not, the pickup delivery time, the travel distance, the fuel consumption and the fuel bill (i.e., the travel cost). The determination unit 140 may determine the optimum combination out of the plurality of combinations based on the delivery company burden calculated in regard to each combination of one or more parcels and a mobile object.

Further, the determination unit 140 may determine the optimum combination out of the plurality of combinations based on the delivery company burden in regard to each combination of one or more parcels and a mobile object, and at least one of the information indicating whether manpower is necessary or not, the pickup delivery time, the travel distance, the fuel consumption and the fuel bill calculated in regard to each combination of one or more parcels and a mobile object. For example, the determination unit 140 determines the optimum combination based on the delivery company burden and the information indicating whether manpower is necessary or not calculated in regard to each combination of one or more parcels and a mobile object. Further, for example, the determination unit 140 determines the optimum combination based on the delivery company burden and the pickup delivery time calculated in regard to each combination of one or more parcels and a mobile object. Furthermore, for example, the determination unit 140 determines the optimum combination based on the delivery company burden and the travel distance calculated in regard to each combination of one or more parcels and a mobile object. Moreover, for example, the determination unit 140 determines the optimum combination based on the delivery company burden and the fuel consumption calculated in regard to each combination of one or more parcels and a mobile object. In addition, for example, the determination unit 140 determines the optimum combination based on the delivery company burden and the fuel bill calculated in regard to each combination of one or more parcels and a mobile object.

### DESCRIPTION OF REFERENCE CHARACTERS

100: information processing device, 101: processor, 102: volatile storage device, 103: nonvolatile storage device, 110: storage unit, 120: acquisition unit, 130: calculation control unit, 140: determination unit, 150: output unit, 200: server, 210: storage unit, 211: mobile object information, 212: parcel information, 213: pickup delivery information, 214: map information, 215: weather information, 216: traffic information, 217: driver information, 220: communication unit

What is claimed is:

1. An information processing device comprising:
acquiring circuitry to acquire mobile object information as information regarding a plurality of mobile objects and including information indicating whether each of the plurality of mobile objects is a manned mobile object or an unmanned mobile object, parcel information as information regarding target parcels as one or more parcels, pickup delivery information as information regarding at least one of pickup and delivery, map information, weather information, and traffic information;
calculation controlling circuitry to calculate a delivery company burden, as a cost defrayment by a delivery company, in regard to each combination of target parcels and a mobile object by using the mobile object information, the parcel information, the pickup delivery information, the map information, the weather information and the traffic information, and generate information indicating whether manpower is necessary or not in regard to each combination of target parcels and a mobile object;
determining circuitry to determine an optimum combination out of a plurality of combinations based on the delivery company burden and the information indicating whether manpower is necessary or not calculated in regard to each combination of target parcels and a mobile object; and
outputting circuitry to output the optimum combination.

2. The information processing device according to claim 1, wherein
the acquiring circuitry acquires driver information as information regarding a driver when a manned mobile object exists in the plurality of mobile objects, and
the calculation controlling circuitry calculates the delivery company burden in regard to each combination of target parcels and a mobile object by using the mobile object information, the parcel information, the pickup delivery information, the map information, the weather information, the traffic information and the driver information.

3. The information processing device according to claim 1, wherein
the calculation controlling circuitry calculates a pickup delivery time, as a time for which at least one of pickup and delivery is carried out, in regard to each combination of target parcels and a mobile object, and
the determining circuitry determines the optimum combination based on the delivery company burden and the pickup delivery time calculated in regard to each combination of target parcels and a mobile object.

4. The information processing device according to claim 1, wherein
the calculation controlling circuitry calculates a travel distance, as a distance in at least one of pickup and delivery, in regard to each combination of target parcels and a mobile object, and
the determining circuitry determines the optimum combination based on the delivery company burden and the travel distance calculated in regard to each combination of target parcels and a mobile object.

5. The information processing device according to claim 4, wherein
the mobile object information includes fuel information as information regarding fuel of each of the plurality of mobile objects,
the calculation controlling circuitry calculates a fuel consumption of the mobile object in at least one of pickup and delivery in regard to each combination of target parcels and a mobile object based on the fuel information and the travel distance, and
the determining circuitry determines the optimum combination based on the delivery company burden and the fuel consumption calculated in regard to each combination of target parcels and a mobile object.

6. The information processing device according to claim 5, wherein
the fuel information includes a unit price of the fuel,
the calculation controlling circuitry calculates a fuel bill in regard to each combination of target parcels and a mobile object based on the unit price and the fuel consumption, and
the determining circuitry determines the optimum combination based on the delivery company burden and the fuel bill calculated in regard to each combination of target parcels and a mobile object.

7. The information processing device according to claim 1, wherein the pickup delivery information indicates a pickup delivery designation position as at least one of a recipient designation position being a position designated by a recipient and a sender designation position being a position designated by a sender.

8. The information processing device according to claim 7, wherein
the pickup delivery information includes the recipient designation position and a recipient designation time as a reception time designated by the recipient,
the acquiring circuitry acquires a present position of the recipient,
the calculation controlling circuitry judges whether the target parcel can be delivered to the recipient designation position at the recipient designation time or not based on the mobile object information, the parcel information, the pickup delivery information, the map information, the weather information, the traffic information and the present position, and
the outputting circuitry outputs a result of the judgment to the recipient's terminal device.

9. The information processing device according to claim 7, wherein
the acquiring circuitry acquires a present position of the recipient,
the calculation controlling circuitry calculates a time when the recipient can receive the target parcel at the recipient designation position based on the mobile object information, the parcel information, the pickup delivery information, the map information, the weather information, the traffic information and the present position, and
the outputting circuitry outputs the calculated time to the recipient's terminal device.

10. An information processing system comprising:
one or more servers that stores mobile object information as information regarding a plurality of mobile objects and including information indicating whether each of the plurality of mobile objects is a manned mobile object or an unmanned mobile object, parcel information as information regarding target parcels as one or more parcels, pickup delivery information as information regarding at least one of pickup and delivery, map information, weather information, and traffic information; and
an information processing device,
wherein the information processing device includes:
acquiring circuitry to acquire the mobile object information, the parcel information, the pickup delivery information, the map information, the weather information and the traffic information from the one or more servers;
calculation controlling circuitry to calculate a delivery company burden, as a cost defrayment by a delivery company, in regard to each combination of target parcels and a mobile object by using the mobile object information, the parcel information, the pickup delivery information, the map information, the weather information and the traffic information, and generates information indicating whether manpower is necessary or not in regard to each combination of target parcels and a mobile object;
determining circuitry to determine an optimum combination out of a plurality of combinations based on the delivery company burden and the information indicating whether manpower is necessary or not calculated in regard to each combination of target parcels and a mobile object; and
outputting circuitry to output the optimum combination.

11. An information processing method performed by an information processing device, the information processing method comprising:
acquiring mobile object information as information regarding a plurality of mobile objects and including information indicating whether each of the plurality of mobile objects is a manned mobile object or an unmanned mobile object, parcel information as information regarding target parcels as one or more parcels, pickup delivery information as information regarding at least one of pickup and delivery, map information, weather information, and traffic information;
calculating a delivery company burden, as a cost defrayment by a delivery company, in regard to each combination of target parcels and a mobile object by using the mobile object information, the parcel information, the pickup delivery information, the map information, the weather information and the traffic information and generating information indicating whether manpower is necessary or not in regard to each combination of target parcels and a mobile object;
determining an optimum combination out of a plurality of combinations based on the delivery company burden and the information indicating whether manpower is necessary or not calculated in regard to each combination of target parcels and a mobile object; and
outputting the optimum combination.

12. An information processing device comprising:
a processor to execute a program; and
a memory to store the program which, when executed by the processor, performs processes of,
acquiring mobile object information as information regarding a plurality of mobile objects and including information indicating whether each of the plurality of mobile objects is a manned mobile object or an unmanned mobile object, parcel information as information regarding target parcels as one or more parcels, pickup delivery information as information regarding at least one of pickup and delivery, map information, weather information, and traffic information,
calculating a delivery company burden, as a cost defrayment by a delivery company, in regard to each combination of target parcels and a mobile object by using the mobile object information, the parcel information, the pickup delivery information, the map information, the weather information and the traffic information and generating information indicating whether manpower is necessary or not in regard to each combination of target parcels and a mobile object,
determining an optimum combination out of a plurality of combinations based on the delivery company burden and the information indicating whether manpower is necessary or not calculated in regard to each combination of target parcels and a mobile object, and
outputting the optimum combination.
